(19) United States
(12) Patent Application Publication
(10) Pub. No.: US 2025/0064090 A1
(43) Pub. Date: Feb. 27, 2025

(54) Feed Additive

(71) Applicant: EW Nutrition GmbH, Visbek (DE)

(72) Inventors: Andreas Michels, Duesseldorf (DE); Maira Peres de Carvalho, Koeln (DE); Uemit Pul, Duisburg (DE)

(21) Appl. No.: 18/255,384

(22) PCT Filed: Dec. 3, 2021
(86) PCT No.: PCT/EP2021/084122

§ 371 Date: Jun. 1, 2023

(30) Foreign Application Priority Data
Dec. 3, 2020 (DE) 20211633.1

(51) Int. Cl. A23K 20/158; A23K 20/105; A23K 20/111

(52) U.S. Cl. CPC A23K 20/158; A23K 20/105; A23K 20/111

(57) ABSTRACT

The invention pertains to a feed additive comprising conjugation inhibitor and a conjugation enhancer and/or a conjugation inert ingredient wherein the feed additive has an anti-oxidation activity of at least 1 TE.

The present invention relates to feed additives.

Feed additives are commonly used in feed for animals. Such feed additives generally have a positive effect on the gut microbiota of the animal, on the digestion and uptake of nutrients, on daily weight gain and on the health of the animal.

WO 2008/15536 discloses a feed additive comprising cinnamaldehyde and a compound selected from citral, eugenol, limonene, thymol and vanillin. This feed additive is capable of inhibiting the growth or reducing the population of pathogenic bacteria in an animal, and increases the growth of beneficial bacteria. This international publication does not describe or hint to the development of bacterial resistance and how to reduce such resistance development.

In WO 2020/208344 the combination of carvacrol and thymol, optionally with p-cymene, is used against cephalosporin-resistant Enterobacteriaciae. This international publication is concerned with bactericidal activity against resistant bacteria strains, which is different from reducing the development of bacterial resistance.

Cabazon et al (2017; doi 10.3389/fmicb.2017.02329) eludes to compounds that are capable of inhibiting bacterial conjugation. Examples of such compounds include dehydrocrepenynic acid, 2-hexadecynoic acid and tanzawaic acids A and B. Cabezon et al further indicate that many compounds, such as palmitic acid, are unspecific growth inhibitors, and not conjugation inhibitors. Fernando-Lopez et al (2015; doi 10.1099/mic.0.28216-0) assessed many compounds for their conjugation inhibitory effect. The only compounds that were found to inhibit conjugation in plasmids R388, R1 and RP4 were linoleic acid and dehydrocrepenynic acid. Garcia-Cazorla et al (2018; doi 10.1074/jbc.RA118.004716) looked into the conjugation inhibition behaviour of 2-hexadecynoic acid and 2-bromopalmitic acid. All three references study the inhibition of bacterial conjugation per se and the compounds inhibiting this conjugation. There is no reference to the use of these compounds in feed additives or in animal feed. Moreover, the inhibitory effect in mixtures or the conjugation frequency of feed additive mixtures is not assessed.

The effect that feed additives may have on the development of resistance in the bacteria present in the gut of the animal is generally underexposed or not looked at. The present invention aims to overcome this knowledge gap.

The objective of the present invention is to provide novel feed additives.

The invention pertains to a feed additive comprising a conjugation inhibitor and a conjugation enhancer and/or a conjugation inert ingredient wherein the feed additive has an anti-oxidation activity of at least 1 Trolox Equivalent (TE). With “conjugation” is meant the process of transferring genetic material, e.g. transferring a plasmid, from one bacterium to another bacterium. A conjugation inhibitor is capable of reducing conjugation in bacteria. In particular when bacteria are exposed to compounds capable of increasing conjugation in bacteria, the conjugation inhibitor will reduce the level of conjugation, even to a level below the control, i.e. when bacteria are not exposed to compounds affecting the conjugation level. Preferably, the feed additive reduces conjugation to below the conjugation observed for the control. The conjugation enhancer is capable of increasing the conjugation level or the plasmid transfer when compared to the control. Such conjugation enhancers generally tend to increase the probability of the bacteria to develop resistance towards antibiotics. The conjugation inert ingredient refers to feed additive ingredients that do not exhibit an effect on conjugation frequency compared to the control. The conjugation inhibitor, conjugation enhancer and/or the conjugation inert ingredient may have other capabilities such as antimicrobial activity and/or anti-oxidant activity. It was found that the conjugation is related to the expression of hemolysin in the bacteria. When hemolysin is expressed less, a lower level of conjugation is observed. The conjugation inhibitor is generally capable of reducing the expression of hemolysin. The feed additive of the invention may further reduce the resistance development in bacteria. In addition, the conjugation inhibitor of the invention allows for a broader application and number of feed additive ingredients, including conjugation enhancers, without significantly contributing to conjugation enhancement and/or resistance development.

The level of conjugation can be determined using known methods in the art. An example of such a method is disclosed in Headd et al (in “Physicochemical Factors That Favor Conjugation of an Antibiotic Resistant Plasmid in Non-growing Bacterial Cultures in the Absence and Presence of Antibiotics.” Frontiers in microbiology vol. 9 2122. 11 Sep. 2018, doi: 10.3389/fmicb.2018.02122). Preferably, the method to determine conjugation or the conjugation frequency comprises incubating Escherichia coli strains HT-99 (chloramphenicol resistant) and J53R (ampicillin resistant) separately in LB medium, at 37° C., 100 rpm during 16hours. Strain HT-99, or donor, carries a transferable plasmid, which confers chloramphenicol resistance. Strain J53R, or receptor, carries the gene AmpC, conferring resistance to ampicillin. 1 mL of each strain is pipetted in 8 mL LB medium (10 mL total) containing 10 μL of compound or mixture. A control containing only 10 uL of DMSO is prepared. Flasks are incubated at 37° C., 100 rpm during 3 hours. After the incubation time, the cultures are serially diluted in 0,9% NaCl and 100 μL spread on LB Agar containing: a) 64 mg/L ampicillin, b) 64 mg/L chloramphenicol and c) both antibiotics—64 mg/L each. Plates are incubated at 37° C. overnight, colony forming units (CFU/mL) counted and conjugation frequency determined. The conjugation frequency F_{C} is defined as C_{TC}/(C_{D}+C_{R}+C_{TC}), wherein C_{TC} is the concentration (number per volume) of transconjugants, C_{D} is the concentration of donor bacteria (E. coli strain HT-99) and C_{R} is the concentration of receptor bacteria (incubating E. coli strain J53R). When a lower conjugation frequency is determined, e.g. when a sample with a conjugation inhibitor is compared to a control sample, the conjugation is considered to be lower or reduced. When a higher conjugation frequency is determined, e.g. when a sample with a conjugation enhancer is compared to a control sample, the conjugation is considered to be higher or increased. When a conjugation frequency is determined which is not significantly different from the conjugation frequency observed for the control, e.g. when a sample with a conjugation inert ingredient is compared to a control sample, the conjugation is considered to be unaltered or the same as observed for the control. For the determination whether an ingredient is a conjugation inhibitor, a conjugation enhancer or a conjugation inert ingredient, the conjugation frequency is determined of the sole ingredient. To determine whether the feed additive has a conjugation frequency below the conjugation frequency of the conjugation enhancer or of the ingredients without the conjugation inhibitor or a conjugation frequency below the control, the conjugation frequency of the feed additive is determined and compared accordingly.

In one embodiment, the conjugation inhibitor reduces the plasmid transfer caused by a conjugation enhancer. Preferably, the conjugation inhibitor reduces the plasmid transfer or conjugation caused by a conjugation enhancer to below the conjugation observed for the control. More preferably, the conjugation observed for the feed additive of the invention is at most 80% of the conjugation observed for the control, even more preferably at most 60%, even more preferably at most 40% and most preferably at most 20% of the conjugation observed for the control.

In one embodiment, the weight ratio between the conjugation inhibitor and conjugation enhancer is at least 0.01, preferably at least 0.05, more preferably at least 0.1 and most preferably at least 0.2, and preferably at most 3, more preferably at most 1, and most preferably at most 0.8. When two or more conjugation inhibitors are present, the weight of the conjugation inhibitor is the total weight of all the conjugation inhibitors. When two or more conjugation enhancers are present, the weight of the conjugation enhancer is the total weight of all the conjugation enhancers.

In one embodiment, the weight ratio between the conjugation inhibitor and conjugation inert ingredient is at least 0.01, preferably at least 0.05, more preferably at least 0.1 and most preferably at least 0.2, and preferably at most 3, more preferably at most 1, and most preferably at most 0.8. When two or more conjugation inert ingredients are present, the weight of the conjugation inert ingredient is the total weight of all the conjugation inert ingredients.

When the feed additive comprises both the conjugation enhancer and the conjugation inert ingredient, the weight ratio between the conjugation enhancer and conjugation inert ingredient is at least 0.01, preferably at least 0.05, more preferably at least 0.1 and most preferably at least 0.2, and preferably at most 3, more preferably at most 1, and most preferably at most 0.8.

In one embodiment, the feed additive of the invention comprises a conjugation inhibitor and a conjugation enhancer and optionally a conjugation inert ingredient wherein the feed additive has an anti-oxidation activity of at least 1 Trolox Equivalent (TE). In another embodiment, the feed additive of the invention comprises a conjugation inhibitor and a conjugation inert ingredient and optionally a conjugation enhancer wherein the feed additive has an anti-oxidation activity of at least 1 Trolox Equivalent (TE). In the case where only conjugation inert ingredients are present in the feed additive, the conjugation is reduced by the conjugation enhancer to below the conjugation observed for the control.

The conjugation inhibitor can be any conjugation inhibitor known in the art. Examples of such conjugation inhibitors include oleic acid, linoleic acid, linalool, tannic acid and precursors thereof. With the term “precursors” is meant compounds that may form and/or release a conjugation inhibitor over time or upon exposure to a component causing the release of the conjugation inhibitor; the release of the conjugation inhibitor can be brought about by hydrolysis and/or an enzymatic reaction. Examples of such precursors include lecithin, monoglycerides, diglycerides and triglycerides, and alkyl esters of oleic acid or linoleic acid. Preferably, the conjugation inhibitor is oleic acid and tannic acid. Most preferably, the conjugation inhibitor is oleic acid. Oleic acid may have an effect, alone or in combination with another feed active ingredient, on the growth of the bacteria, for instance on the proliferation of Streptococcus suisand Enterococcus hirae bacteria. An additional advantage of oleic acid is that it is liquid at room temperature and can hence be easily processed in the feed additive of the invention, in particular to introduce oleic acid and optionally other active feed ingredients in the pores of the porous carrier. Moreover, oleic acid is capable of dissolving other active feed ingredients, in particular relatively hydrophobic ingredients as well as ingredients which are generally solid at room temperature. It is noted that the feed additive may comprise two or more conjugation inhibitors. In particular instances, a conjugation inhibitor may have a conjugation enhancing effect, for example the combination of tannic acid (a conjugation inhibitor) and cinnamaldehyde (a conjugation inert ingredient), but in combination with a second conjugation inhibitor such as oleic acid, the combination of tannic acid and oleic acid reduce the conjugation frequency to below the level of conjugation observed by cinnamaldehyde alone or even the control. In such cases, the combination of tannic acid and oleic acid should be taken as conjugation inhibitors in the feed additive.

In one embodiment, the feed additive may comprise the conjugation inhibitor in an amount of at most 80% by weight (wt %), based on the total weight of the feed additive. Preferably, the conjugation inhibitor is present in an amount of at most 70 wt %, more preferably at most 60wt %, even more preferably at most 50 wt % and most preferably at most 40 wt %, and preferably at least 0.1 wt %, more preferably at least 0.2 wt %, even more preferably at least 0.5 wt % and most preferably at least 1 wt %, based on the total weight of the feed additive.

In one embodiment, the feed additive comprises oleic acid in an amount of at most 15% by weight (wt %), based on the total weight of the feed additive. Preferably, oleic acid is present in an amount of at most 12 wt %, more preferably at most 10 wt %, even more preferably at most 8wt % and most preferably at most 5 wt %, and preferably at least 0.1 wt %, more preferably at least 0.2 wt %, even more preferably at least 0.5 wt % and most preferably at least 1 wt %, based on the total weight of the feed additive.

The feed additive further may comprise a conjugation enhancer. The conjugation enhancer can be any conjugation enhancer known in the art. Examples of such conjugation enhancers include carvacrol, citral, eugenol, methyl thymol and thymol. Preferably, the conjugation enhancer is selected from the group consisting of carvacrol, citral and thymol. Preferably, the conjugation enhancer is carvacrol and thymol. Most preferably, the conjugation enhancer is thymol. In one embodiment, the feed additive comprises two or more conjugation enhancers.

In one embodiment, the feed additive comprises the conjugation enhancer in an amount of at most 80% by weight (wt %), based on the total weight of the feed additive. Preferably, the conjugation enhancer is present in an amount of at most 70 wt %, more preferably at most 60wt %, even more preferably at most 50 wt % and most preferably at most 40 wt %, and preferably at least 1 wt %, more preferably at least 2 wt %, even more preferably at least 5 wt % and most preferably at least 10 wt %, based on the total weight of the feed additive.

The feed additive further may comprise a conjugation inert ingredient. The conjugation inert ingredient can be any conjugation inert ingredient known in the art. Examples of such conjugation inert ingredients include essential oils such as vanillin, cinnamaldehyde, geraniol, menthol and capsicum; organic acids such as formic acid, lactic acid, propionic acid, butyric acid, capric acid, caproic acid, caprylic acid, benzoic acid, palmitic acid, stearic acid and combinations and esters and salts thereof; natural compounds such as tannins and saponins; and polysaccharides such as fructans, β-1,4-mannobiose, galacto-oligosaccharides, manno-oligosaccharides and chyto-oligosaccharides. Preferably, the conjugation inert ingredient is selected from the group consisting of organic acids and natural compounds. Preferably, the conjugation enhancer is an organic acid. In one embodiment, the feed additive comprises two or more conjugation inert ingredients. It is noted that a combination of two conjugation inert ingredient may cause a conjugation enhancing effect, e.g. some combinations with cinnamaldehyde. The conjugation inhibitor according to the invention is then capable of reducing the conjugation frequency of the overall feed additive, preferably reducing the conjugation frequency below the frequency observed for the control.

In one embodiment, the feed additive comprises the conjugation inert ingredient in an amount of at most 80% by weight (wt %), based on the total weight of the feed additive. Preferably, the conjugation inert ingredient is present in an amount of at most 70 wt %, more preferably at most 60 wt %, even more preferably at most 50 wt % and most preferably at most 40 wt %, and preferably at least 1 wt %, more preferably at least 2 wt %, even more preferably at least 5 wt % and most preferably at least 10 wt %, based on the total weight of the feed additive.

The feed additive has an anti-oxidation activity of at least 1 TE. The anti-oxidation activity is the capability of the anti-oxidant to prevent the damages reactive oxygen and/or reactive nitrogen have on biomolecules. This anti-oxidation activity can be measured with methods known in the art. A particularly suitable method is disclosed in AOAC Official Method 2012.23 (entitled “Total Antioxidant Activity: Oxygen Radical Absorbance Capacity (ORAC) Using Fluorescein as the Fluorescence Probe, First Action 2012”). Preferably, the method to determine anti-oxidant activity comprises the steps as described in Examples 4 to 9.

In one embodiment, the anti-oxidation activity of the feed additive is at least 1 Trolox Equivalent (TE). Preferably, the anti-oxidation activity of the feed additive is at least 2 TE, more preferably at least 5 TE, even more preferably at least 10 TE, even more preferably at least 10 TE, even more referably at least 20 TE and most preferably at least 50 TE. In one embodiment, the feed additive comprises an anti-oxidant. Examples of anti-oxidants include propyl gallate, tannic acid, butylated hydroxyanisol (BHA), butylated hydroxytoluene (BHT), alpha-tocopherol, ascorbic acid and its salts. Preferably, the anti-oxidant is propyl gallate, tannic acid and ascorbic acid. More preferably, the anti-oxidant is selected from propyl gallate and tannic acid. It is envisaged that the conjugation inhibitor also exhibits anti-oxidation activity. An example of such a compound is tannic acid. Preferably, the feed additive of the invention comprises tannic acid. In one embodiment, the feed additive comprises tannic acid and a second conjugation inhibitor. The second conjugation inhibitor is a conjugation inhibitor as described above. Preferably, the feed additive of the invention comprises tannic acid and oleic acid.

In one embodiment, the feed additive comprises an anti-oxidant in an amount of at most 15% by weight (wt %), based on the total weight of the feed additive. Preferably, the anti-oxidant is present in an amount of at most 12 wt %, more preferably at most 10 wt %, even more preferably at most 8 wt % and most preferably at most 5 wt %, and preferably at least 0.1 wt %, more preferably at least 0.2 wt %, even more preferably at least 0.5 wt % and most preferably at least 1 wt %, based on the total weight of the feed additive.

In a further embodiment, the feed additive has antimicrobial activity with MIC values for Clostridium perfringens DSM 2943 of at most 2,000 μg/mL, Streptococcus suis DSM 9682 of at most 5,000 μg/mL and Escherichia coli DSM 1103 of at most 5,000 μg/mL. Preferably, the feed additive has antimicrobial activity with MIC values for Clostridium perfringens DSM 2943 of at most 1,500 μg/mL, Streptococcus suis DSM 9682 of at most 3,000 μg/mL and Escherichia coli DSM 1103 of at most 5,000 μg/mL. More preferably, the feed additive has antimicrobial activity with MIC values for Clostridium perfringens DSM 2943 of at most 1,000 μg/mL, Streptococcus suis DSM 9682 of at most 1,000 μg/mL and Escherichia coli DSM 1103 of at most 3,000 ug/mL. With MIC values is meant the minimum inhibitory concentration, and is a well known term in the art. The MIC values can be determined using any method known in the art. The determination of MIC values is described by Wiegand et al (in “Agar and broth dilution methods to determine the minimal inhibitory concentration (MIC) of antimicrobial substances”, Nature Protocols, Vol.3, No.2, 2008, pp. 163-175; doi: 10.1038/nprot.2007.521). Preferably, the method to determine MIC values comprises preparing pre-cultures of tested microorganisms. Bacteria were allowed to grow overnight, at the specific conditions required for their growth. Transparent 96-well microtiter plates are filled with 100 uL medium-Mueller Hinton (MH) for Bacillus licheniformisand Bacillus subtilis, E. coli, Pseudomonas aeruginosa, Salmonella enterica and Staphylococcus aureus, brain heart infusion (BHI) for Enterococcus faecium, E. hirae and S. suis. De Man, Rogosa und Sharpe broth (MRS) for Lactobacillus plantarum and Cooked meat (CM) for C. perfringens. Mixtures are serially diluted, concentration range (in μg/mL): 10.000-5.000-2.500-1.250-625-312-156-78-39-19,5-9,7-4,8. Fresh medium is used to adjust the bacterial cells concentration to the 0.5 McFarland scale. Cultures are further diluted to achieve a cell concentration of 5×10⁵ CFU/mL and 100 μL is pipetted into the well. Final volume is 200 μL. Plates are incubated at 37° C., as follows: Bacillus spp., E. faecium, E. coli, P. aeruginosa, S. enterica, S. aureus, aerobically; E. hirae, L. plantarum and S. suis, microaerophilic; C. perfringens, anaerobically. After 16 hrs incubation, OD600 is read using a plate reader. MICs are determined by OD600 sample—OD blank.

In a further embodiment, the feed additive comprises a solvent. The solvent may be any solvent known in the art and suitable for use in feed and feed additives. Examples of such solvents include water, polyethylene glycol, propylene glycol, polypropylene glycol, ethanol, glycerin, esters of fatty acids, and esters of propylene glycol. Preferably, the solvent is selected from the group consisting of water, propylene glycol, glycerin and ethanol. Most preferably, the solvent is water. Also the combination of two or more solvents is contemplated.

In one embodiment, the feed additive comprises the solvent in an amount of at most 80% by weight (wt %), based on the total weight of the feed additive. Preferably, the solvent is present in an amount of at most 70 wt %, more preferably at most 60 wt %, even more preferably at most 50 wt % and most preferably at most 40 wt %, and preferably at least 1 wt %, more preferably at least 2 wt %, even more preferably at least 5 wt % and most preferably at least 10 wt %, based on the total weight of the feed additive.

In one embodiment of the invention, the feed additive comprises an excipient. The excipient can be any excipient known in the art. Examples of such excipients include micronutrients, vitamins, enzymes, solubilizers, heat stabilizers and colorants.

In one embodiment, the feed additive comprises the excipient in an amount of at most 15% by weight (wt %), based on the total weight of the feed additive. Preferably, the excipient is present in an amount of at most 12 wt %, more preferably at most 10 wt %, even more preferably at most 8 wt % and most preferably at most 5 wt %, and preferably at least 0.1 wt %, more preferably at least 0.2 wt %, even more preferably at least 0.5 wt % and most preferably at least 1 wt %, based on the total weight of the feed additive.

The remaining part of the feed additive may be comprised of other components commonly used in feed additives. With the conjugation inhibitor, the conjugation enhancer, the solvent, the excipient, the other components add up to 100 wt % of the total weight of the feed additive.

The feed additive of the invention can be in any form known in the art. The feed additive may be liquid or may be solids. The feed additive may comprise a controlled release agent, which enables the delayed release of at least one of the components of the feed additive. The controlled release agent may allow the feed active ingredients to be released after the rumen or stomach of the animal. The controlled release agent can be a protective coating as described below. It may be directly applied to the particles, i.e. without a (porous) carrier, or the active feed ingredients may be a least partly dissolved in the controlled release agent.

The present invention further pertains to a feed additive comprising: a porous carrier; a conjugation inhibitor and a conjugation enhancer and/or a conjugation inert ingredient, which are adsorbed onto and/or absorbed into the porous carrier to form a filled porous carrier; and a protective coating applied to the filled porous carrier. The feed additive of the invention enables a delayed release of the active ingredients, i.e. the conjugation inhibitor and the conjugation enhancer and/or the conjugation inert ingredient, as these ingredients are protected in the rumen or stomach of the animal and to be released in the gut of the animal. In the context of this application the wordings “protected” and “protective” refer to the active feed ingredient(s) being covered and shielded from release in the rumen or stomach of the animal, and these ingredients being predominantly released in the gut of the animal. As the porous carrier comprises the conjugation inhibitor and the conjugation enhancer and/or the conjugation inert ingredient, the protective coating can cover and protect these ingredients from external exposure, e.g. to the acid and/or alkaline compounds in the rumen or stomach. In this way, the conjugation inhibitor and the conjugation enhancer and/or the conjugation inert ingredient are released in the gut and capable of influencing the microbes present in the gut. It was found that oleic acid is capable of reducing or even diminishing the conjugation between bacteria. The feed additive further has the advantages described above. Moreover, the embodiments described above can also be applied to this feed additive.

The feed additive may comprise of particles, the d50 value of the feed additive is generally at most 1,500 μm, preferably at most 1,200 μm, more preferably at most 1,000 μm, even more preferably at most 800 μm and most preferably at most 500 μm, and generally at least 50 μm, preferably at least 75 μm, more preferably at least 100 μm and most preferably at least 150 μm.

The d50 value is a measure for the particle size distribution of particles, which can be determined using conventional techniques such as laser diffraction. The particles can be a single porous carrier particle or an agglomerate of particles of the porous carrier. In a preferred embodiment, the porous carrier comprises single particles with the d50 value as indicated above, e.g. single particles of precipitated silica. In one embodiment, such single carrier particles comprise the conjugation inhibitor and the conjugation enhancer and/or the conjugation inert ingredient absorbed therein and/or adsorbed thereon, preferably absorbed therein; each filled particle is subsequently covered with a protective coating.

Alternatively or additionally, the feed additive particles have a d90 value of at most 2,000 μm, preferably at most 1,500 μm, more preferably at most 1,200 μm, even more preferably at most 1,000 μm and most preferably at most 800 μm, and generally at least 50 μm, preferably at least 75 μm, more preferably at least 100 μm and most preferably at least 150 μm. The d90 value is a measure for the particle size distribution of particles, which can be determined using conventional techniques such as laser diffraction.

In one embodiment, the feed additive comprises the porous carrier in an amount of at most 50% by weight (wt %), based on the total weight of the feed additive. Preferably, the porous carrier is present in an amount of at most 40 wt %, more preferably at most 30 wt %, even more preferably at most 25 wt % and most preferably at most 20 wt %, and preferably at least 0.1 wt %, more preferably at least 1 wt %, even more preferably at least 5 wt % and most preferably at least 10 wt %, based on the total weight of the feed additive.

The feed additive of the invention comprises the conjugation inhibitor and the conjugation enhancer and/or the conjugation inert ingredient. In one embodiment, the feed additive may comprise the conjugation inhibitor and the conjugation enhancer and/or the conjugation inert ingredient in an amount of at most 30% by weight (wt %), based on the total weight of the feed additive. Preferably, the conjugation inhibitor and the conjugation enhancer and/or the conjugation inert ingredient is present in an amount of at most 25 wt %, more preferably at most 20 wt %, even more preferably at most 18 wt % and most preferably at most 15 wt %, and preferably at least 0.1 wt %, more preferably at least 0.2 wt %, even more preferably at least 0.5wt % and most preferably at least 1 wt %, based on the total weight of the feed additive.

The feed additive of the invention further comprises a protective coating. The protective coating serves to protect the oleic acid and optionally the second active feed ingredient to exposure in the rumen or stomach of the animal so that oleic acid and optionally the second active feed ingredient is released in the gut of the animal. With “gut” is meant the gastrointestinal tract following the rumen or stomach, and includes the colon, jejunum and caecum. The protective coating can be any protective coating known in the art. Examples of protective coatings include vegetable oils such as sunflower oil, soybean oil, palm oil and coconut oil; hydrogenated vegetable oils such as hydrogenated palm oil, hydrogenated soybean oil, hydrogenated rapeseed oil, hydrogenated cotton seed oil and hydrogenated castor oil; animal oils such as beef tallow, fish oil and sheep tallow; hydrogenated animal oils such as hydrogenated beef tallow, beef lard, hydrogenated fish oil; pH dependent polymers such as polyethylene wax and copoly(2-vinyl pyridine-styrene) and cellulose propionate morpholinobutyrate (CPMB); and fatty acids having at least 14 carbon atoms such as behenic acid, stearic acid and palmitic acid. Preferably, the protective coating is vegetable oil or animal oil. Most preferably, the protective coating is vegetable oil. Also combination of two or more protective coatings are envisaged. In one embodiment, the feed additive comprises the protective coating in an amount of at most 50% by weight (wt %), based on the total weight of the feed additive. Preferably, the protective coating is present in an amount of at most 40 wt %, more preferably at most 30 wt %, even more preferably at most 25 wt % and most preferably at most 20 wt %, and preferably at least 0.1 wt %, more preferably at least 1 wt %, even more preferably at least 5 wt % and most preferably at least 10 wt %, based on the total weight of the feed additive.

The remaining part of the feed additive may be comprised of other components commonly used in feed additives. With the porous carrier, the conjugation inhibitor and the conjugation enhancer and/or the conjugation inert ingredient and the protective coating the other components add up to 100 wt % of the total weight of the feed additive.

The feed additive may further comprise additives such as heat stabilizers, flame retardants, UV stabilizers, fungicides, biocides, perfumes, relaxers, colorants, fillers, pigments and dyes, thickeners, preservatives, anti-oxidants, freeze thaw stabilizers, moisturizers, pH controlling agents, water phase stabilizing agents, vitamins, sebum absorbants, active ingredients and antifoams.

The additive can be chosen according to need in amounts as desired. The feed additive of the invention may comprise the additive in an amount of at most 30% by weight (wt %), based on the total weight of the feed additive. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the feed additive.

The feed additive of the invention can be prepared using conventional techniques for producing such feed additives. Such techniques include mixing, heating, drying including fluidized bed drying or spray drying. Generally, a free flowing powder of the feed additive of the invention is formed.

The invention further pertains to a feed composition comprising the feed additive of the invention wherein the amount of the feed additive ingredient is from 0.001 to 1 wt %, based on the feed composition. The feed additive may have the same embodiments as described above.

The feed composition may further comprise feed excipients that are generally used in feed compositions such as nutrients and minerals or excipients capable of improving the uptake of the feed additive ingredient or delaying its uptake to more downstream in the gut. The feed composition of the invention may be used for livestock animals such as ruminants, swine and poultry. The skilled person will appreciate that feed composition will differ in composition depending on the animal.

The feed composition of the invention may comprise the feed additive in an amount of at most 1% by weight (wt %), based on the total weight of the feed composition. Preferably, the feed additive is present in an amount of at most 0.8 wt %, more preferably at most 0.5 wt %, even more preferably at most 0.3 wt % and most preferably at most 0.2 wt %, and preferably at least 0.005 wt %, more preferably at least 0.01 wt %, even more preferably at least 0.05 wt % and most preferably at least 0.1 wt %, based on the total weight of the feed composition.

The invention further pertains to the use of oleic acid to reduce plasmid transfer, in particular in bacteria. Alternatively, the invention pertains to the use of oleic acid to reduce conjugation, in particular in bacteria.

A brief description of the Figures is given below.

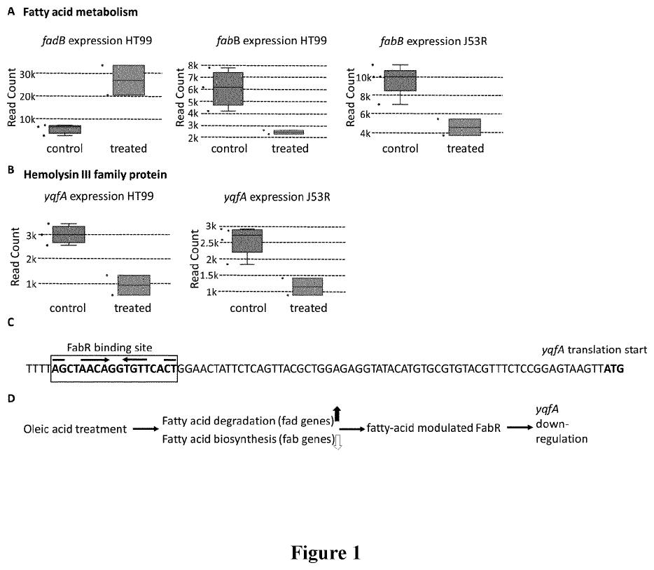

FIG. 1A: Fatty acid metabolism in donor and receptor bacteria: fatty acid degradation (fadB) and inhibition of fatty acid biosynthesis (fabB) genes upon treatment with oleic acid

FIG. 1B: Hemolysin III protein expression: yqfA expression in donor and receptor bacteria

FIG. 1C: The FabR binding site upstream of the yqfA gene

FIG. 1D: Relationship between oleic acid treatment and yqfA down regulation

The invention is exemplified in the following Examples.

### Examples

### Example 1: Bacterial Conjugation in Liquid Medium

Compounds stock solutions: carvacrol, cinnamaldehyde, citral, thymol, linalool, oleic acid and tannic acid were prepared in DMSO in a concentration of 100 mg/mL.

Mixtures stock solution preparation: 100 mg of a compound showing to increase plasmid transfer is mixed with 100 mg of a compound which inhibits plasmid transfer. DMSO is added to complete 1 mL.

E. coli strains HT-99 (chloramphenicol resistant) and J53R (ampicillin resistant) are incubated separately in LB medium, at 37° C., 100 rpm during 16 hours. Strain HT-99, or donor, carries a transferable plasmid, which confers chloramphenicol resistance. Strain J53R, or receptor, carries the gene AmpC, conferring resistance to ampicillin. 1 mL of each strain is pipetted in 8mL LB medium (10 mL total) containing 10 μL of compound or mixture. A control containing only 10 μL of DMSO is prepared. Flasks are incubated at 37° C., 100 rpm during 3 hours. After the incubation time, the cultures are serially diluted in 0,9% NaCl and 100 μL spread on LB Agar containing: a) 64 mg/L ampicillin, b) 64 mg/L chloramphenicol and c) both antibiotics—64 mg/L each. Plates are incubated at 37° C. overnight and colony forming units (CFU/mL) counted. Experiments were performed in biological duplicates, technical triplicates.

The conjugation frequency F_{C} is defined as C_{TC}/(C_{D}+C_{R}+C_{TC}), wherein C_{TC} is the concentration (number per volume) of transconjugants, C_{D} is the concentration of donor bacteria (E. coli strain HT-99) and C_{R} is the concentration of receptor bacteria (incubating E. coli strain J53R). The formula used to calculate conjugation frequency varies in the literature. Conjugation requires both a donor and a recipient and omitting one of both populations, particularly if the initial inoculate contains more donor or recipient bacteria, artificially inflates conjugation frequencies (Headd and Bradford, 2018).

The conjugation frequency was determined for the single components carvacrol, cinnamaldehyde, citral, thymol, linalool, oleic acid and tannic acid. In the control no ingredients were added (only DMSO). The conjugation frequencies for each ingredient are shown in the Table below.

TABLE 1
the conjugation frequency of samples treated with
100 mg/L of the single tested substances

| | Conjugation | Standard |
|---|---|---|
| Ingredient | frequency | Deviation |
| Control | 0.0013 | 0.0001 |
| Carvacrol | 0.0044 | 0.0002 |
| Cinnamaldehyde | 0.0011 | 0.0002 |
| Citral | 0.0023 | 0.0001 |
| Thymol | 0.0019 | 0.0003 |
| Oleic acid | 0.00011 | 0.00006 |
| Linalool | 0.00085 | 0.00004 |
| Tannic acid | 0.00007 | 0.000008 |

From Table 1 it is shown that oleic acid, linalool and tannic acid are conjugation inhibitors. Carvacrol, citral and thymol are conjugation enhancers and cinnamaldehyde is a conjugation inert ingredient. Of the conjugation inhibitors oleic acid and tannic acid are reducing the plasmid transfer between bacteria strongest.

The conjugation frequency of carvacrol combined with the different conjugation inhibitors was assessed. The results are shown in the table below.

Table 2 demonstrates that the conjugation inhibitors used are capable of reducing the conjugation frequency of the conjugation enhancer carvacrol to the conjugation frequency observed for the control (linalool) or well below this conjugation level (oleic acid, tannic acid and oleic acid and tannic acid).

TABLE 2
the conjugation frequency of samples treated with carvacrol
alone, carvacrol + linalool, carvacrol + oleic acid, carvacrol + tannic
acid and carvacrol + oleic acid + tannic acid. When
carvacrol alone is added an increase in conjugation is verified.
Linalool and tannic acid were able to decrease the negative effects
of carvacrol to control level. Oleic acid was able to
mitigate negative impacts of carvacrol.

| | | Standard |
|---|---|---|
| Ingredient | Conjugation frequency | Deviation |
| Control | 0.0012 | 0.0001 |
| Carvacrol | 0.0052 | 0.0004 |
| Carvacrol and linalool | 0.0013 | 0.0001 |
| Carvacrol and oleic | 0.00006 | 0.00002 |
| acid | | |
| Carvacrol and tannic | 0.0009 | 0.00005 |
| acid | | |
| Carvacrol, tannic acid | 0.00008 | 0.00001 |
| and oleic acid | | |

The conjugation frequency of cinnamaldehyde combined with the different conjugation inhibitors was assessed. The results are shown in the table below.

TABLE 3
the conjugation frequency of samples treated with cinnamaldehyde
alone, cinnamaldehyde + linalool, cinnamaldehyde + oleic acid,
cinnamaldehyde + tannic acid and
cinnamaldehyde + oleic acid + tannic acid

| | | Standard |
|---|---|---|
| Ingredient | Conjugation frequency | Deviation |
| Control | 0.0013 | 0.0001 |
| Cinnamaldehyde | 0.0014 | 0.0001 |
| Cinnamaldehyde and linalool | 0.0013 | 0.0002 |
| Cinnamaldehyde and oleic acid | 0.0008 | 0.0001 |
| Cinnamaldehyde and tannic acid | 0.002 | 0.0001 |
| Cinnamaldehyde, tannic acid and | 0.0009 | 0.00008 |
| oleic acid | | |

When cinnamaldehyde alone is added conjugation is not affected. However, in combination with tannic acid, a significant increase in conjugation frequency was detected. Oleic acid was able to decrease conjugation frequency not only when applied alone but also in combination with tannic acid.

The conjugation frequency of citral combined with the different conjugation inhibitors was assessed. The results are shown in the table below.

TABLE 4
the conjugation frequency of samples treated with citral alone,
citral + linalool, citral + oleic acid and citral + tannic acid.

| | | Standard |
|---|---|---|
| Ingredient | Conjugation frequency | Deviation |
| Control | 0.0014 | 0.0001 |
| Citral | 0.0028 | 0.0001 |
| Citral and linalool | 0.0016 | 0.0001 |
| Citral and oleic | 0.00001 | 0.000001 |
| acid | | |
| Citral and tannic | 0.0012 | 0.0001 |
| acid | | |

Table 4 demonstrates that the conjugation inhibitors used are capable of reducing the conjugation frequency of the conjugation enhancer citral to the conjugation frequency observed for the control (linalool and tannic acid) or well below this conjugation level (oleic acid).

### Example 2: Gene Expression Analysis of Oleic Acid Treated Donor and Recipient Cells

To analyze the effect of oleic acid on cell metabolism and conjugation frequency at molecular level whole-genome transcriptome analysis was performed. The genomes of the donor HT99and recipient J53R cells were sequenced using Nanopore sequencer and assembled with Flye (https://www.nature.com/articles/s41587-019-0072-8). The assembly resulted in five contigs for HT99 chromosomal DNA and two circularized plasmids. Total size of genomic DNA of HT99 is 4.9 Mbp with one 84310-bp plasmid (termed pHT99_84) and a second plasmid of 48851 bp (termed pHT99_48). The plasmid pHT99_84 belongs to the incompatibility (inc) group IncF and contains the chloramphenicol resistance genes used in the conjugation assays as described above. The assembly of the Nanopore reads obtained from J53R genome sequencing resulted in a chromosomal DNA of 4.7 MBp and a circularized plasmid of 22335 Bp (termed pJ53R).

Total RNA from HT99 or J53R cells, each treated either with DMSO (control samples) or oleic acid (treatment) were isolated with hot phenol-chloroform extraction as described previously (https://www.ncbi.nlm.nih.gov/pmc/articles/PMC3737329/#R13). Two biological replicates from oleic acid treated cells and four biological replicates from DMSO-treated control cells were prepared. The rRNA depletion, mRNA library generation and Illumina NextSeq sequencing (non-stranded, 1x 75 bp, 100 M total raw reads) occurred at external sequencing service provider. Data preparation for differential gene expression analyzes were carried out using Bowtie2 aligner (https://academic.oup.com/bioinformatics/article/35/3/421/5055585) and samtools (https://pubmed.ncbi.nlm.nih.gov/19505943/). For each sample the alignment rate of the RNA reads was >97%. The mapping qualities of each sample were verified by visualization of the mapped reads using IGV tool (https://www.ncbi.nlm.nih.gov/pmc/articles/PMC3346182/).

For differential expression analysis, the mapped reads were counted using Htseq-count (https://www.ncbi.nlm.nih.gov/pmc/articles/PMC4287950/). Differential RNA-seq analyses were performed using DEBrowser package (https://bmcgenomics biomedcentral.com/articles/10.1186/s 12864-018-5362-x) using data obtained from two biological replicates of oleic acid treated HT99 or J53R and three or four biological replicates of DMSO-treated HT99 or J53R, respectively.

The box plots in FIG. 1A and B show the normalized read counts of indicated genes in each treated and non-treated cells (with fold change≥two-fold, Padj<0.01). The data show that oleic acid is internalized leading to the adaptation of the cell to the excess of oleic acid by inducing the fatty acid degradation (fadB) and inhibition of fatty acid biosynthesis (fabB) genes upon treatment with oleic acid (FIG. 1A, FC: fold-change). In addition to fabB, the expression of the yqfA gene (encoding for a hemolysin III family protein) is also reduced in both cells upon treatment (FIG. 1B). YqfA is an inner membrane channel protein with seven predicted transmembrane domains, conserved in gram negative bacteria and a virulence factor suggested to enhance survival of Streptococcus suis in blood (https://www.ncbi.nlm.nih.gov/pmc/articles/PMC6490898/). The molecular basis of yqfA down-regulation by oleic acid relies likely on the presence of a FabR-binding site (FIG. 1C) located upstream of the translation site of yqfA in HT99 and J53R. According to the study by Feng and Cronan, 2011 (https://www.ncbi nim.nih gov/pmc/articles/PMC4072462/) FabR binds in presence of long chain unsaturated acyl-CoA upstream of the yqfA gene. Therefore, it is concluded that oleic acid is internalized by the cells and inhibits plasmid transfer not indirectly through affecting the bacterial membrane fluidity but rather directly through modulating the fatty acid metabolic response linked to hemolysin III expression (FIG. 1D).

### Examples 3 to 8: Feed Additives

Various feed additives were prepared; the feed additives of Examples 3 to 8 are in accordance with the invention, and Comparative Example A is not in accordance with the invention. He conjugation was determined using the method described in Example 1.

Determination of the anti-oxidant activity

The method to determine anti-oxidant activity comprises a method where the capacity of antioxidants to protect the fluorescent substance from damage by free radicals is measured. Peroxyl radical are originated trough thermic decompositions of 2,2′-azobis (2-amidino-propane) dihydrochloride (AAPH). Fluorescein (FL) fluorescence drops due to the reaction with the peroxyl radical released by AAPH. An antioxidant agent is able to protect FL fluorescence loss.

Reagents preparation:

| | |
|---|---|
| Trolox | 10 mM (2.5 mg/mL) in Phosphate Buffer pH 7.4 |
| AAPH | 50 mg/ml in H₂O |
| Fluorescein | 1 mM in H₂O |
| Phosphate Buffer | 10 mM pH 7.4 |
| Mixtures | 2 mg/mL in Phosphate Buffer pH 7.4 |

Method

Add 200 μL of Phosphate buffer 10 mM, pH 7,4 to each well in the border of black 96-well microtiter plate. Dilute Fluorescein to 1 μM in phosphate buffer (14 μL Fluorescein 1 mM in 14 mL Phosphate buffer 10 mM, pH 7,4). Add 150 μL Fluorescein 1 μM to all other wells.

1) Mixtures stock solution: Add 2 mg of the mixture in 998 μL Phosphate buffer 10 mM, pH 7,4.

2) Put 150 μL of Stock solution 1 in the column 2 of a transparent flat bottom 96-well plate (in duplicate).

3) Put 50 μL of Phosphate buffer in each well from the column 3 to 11 (in the rows from B to G).

4) Trolox (200 μM): Add 9 μL Trolox 10 mM in 441 μL Phosphate buffer. Put 150 μL in the column 2 of a transparent flat bottom 96-well plate (in duplicate).

6) Serial dilution: Pipette 100 μL of the first well (column 2) into the second well (column 3) to obtain the dilution 2. Mix and take 100 μL from the column 3 to the column 4 to obtain the dilution 3. Do the same for all the dilutions. At the dilution 9 (column 10), mix and take out 100 μL to have only 50 μL left in the well.

7) Transfer 25 μL from each well to a 96-well black plate previously prepared with 150 μL Fluorescein 1 μM.

Incubation

Incubate the 96-well black plate at 37° C. for 30 min to equilibrate the solutions to the assay temperature.

Measurement

After the incubation, start the measurement by measuring the “baseline” fluorescence for five minutes in 30 sec intervals by using a Tecan F500 with the following parameters:

| | | |
|---|---|---|
| Temperature | 37° | C. |
| Excitation Wavelength | 485 | nm |
| Emission Wavelength | 535 | nm |
| Excitation Bandwidth | 20 | nm |
| Emission Bandwidth | 25 | nm |
| Gain | 24 | Manual |
| Number of Flashes | 10 | |
| Integration Time | 20 | μs |
| Lag Time | 0 | μs |
| Settle Time | 0 | ms |

| | |
|---|---|
| Mirror (Automatic) | Dichroic 510 |

Subsequently, add 25 μl AAPH solution 50 mg/ml to each well to start the reaction (do not add to the wells of the border). This has to be done quickly using a multidrop or multichannel pipette. The reaction starts immediately.

Return the plate to Tecan to continue the measurements for 120 minutes.

Calculation

The area under the curve (AUC) is calculated for mixture and Trolox. Net AUC is calculated by (AUC sample-AUC blank). ORAC results are expressed in trolox equivalents (TE). Trolox equivalents are calculated using linear regression analysis, by using the ratio between sample slope range and Trolox slope range.

MIC value determination

The method to determine MIC values comprises preparing pre-cultures of tested microorganisms. Bacteria were allowed to grow overnight, at the specific conditions required for their growth. Transparent 96-well microtiter plates are filled with 100 uL medium-Mueller Hinton (MH) for Bacillus spp., E. coli, P. aeruginosa, S. enterica, S. aureus and, brain heart infusion (BHI) for S. suis and Enterococcus spp. De Man, Rogosa und Sharpe broth (MRS) for L. plantarum and Cooked meat (CM) for C. perfringens. Mixtures are serially diluted, concentration range (in ug/mL): 10.000-5.000-2.500-1.250-625-312-156-78-39-19,5-9,7-4,8. Fresh medium is used to adjust the bacterial cells concentration to the 0.5 McFarland scale. Cultures are further diluted to achieve a cell concentration of 5×10⁵ CFU/mL and 100 μL is pipetted into the well. Final volume is 200 μL. Plates are incubated at 37° C., as follows: Bacillus spp., E. faecium, E. coli, P. aeruginosa, S. enterica, S. aureus, aerobically; E. hirae, L. plantarum and S. suis, microaerophilic; C. perfringens, anaerobically. After 16 hrs incubation, OD600 is read using a plate reader. MICs are determined by OD600 sample—OD blank.

Evaluation of the feed additives

The anti-oxidation activity, relative conjugation frequencyand MIC values for various bacterial strains were determined and shown in Table 5. The “relative conjugation frequency” is defined as the conjugation frequency of the Example compared to the conjugation frequency of the control expressed in percentage (%).

All the feed additives of Examples 3 to 8 combine good conjugation inhibition with a good anti-oxidation activity. The feed additive of Comparative Example A has good anti-oxidant activity but shows a high level of conjugation. The feed additives of the invention furthermore have MIC value for Clostridium perfringens DSM 2943 of 1,250 μg/mL or lower, and MIC values for Streptococcus suis DSM 9682 of at most 625 μg/mL or lower, and MC values for Escherichia coli DSM 1103 of 5,000 ug/mL or lower.

TABLE 5
Compositions of various feed additives with their anti-oxidation activity,
relative conjugation frequency (compared to the control) and MIC values
for various bacterial strains

| | Examples | | | | | | |
|---|---|---|---|---|---|---|---|
| Compound | 3 | A | 4 | 5 | 6 | 7 | 8 |
| Cinnamaldehyde | 10.0% | 2.0% | | | | | |
| Thymol | | 8.0% | 10.0% | 12.0% | 12.0% | 10.0% | 9.0% |
| Vanillin | | 1.5% | 0.5% | 2.0% | 2.0% | 3.0% | 1.0% |
| Capric/caprylic acid | 1.5% | 2.0% | 1.0% | 1.0% | 1.0% | 2.0% | 3.0% |
| Tannic acid | 1.5% | 1.5% | 1.5% | 3.0% | 3.0% | 3.0% | 1.5% |
| Oleic acid | 2.0% | | 2.0% | 2.0% | 3.0% | 2.0% | 4.0% |
| Anti-oxidantion activity | 24 | 92 | 95 | 124 | 115 | 90 | 86 |
| (Trolox equivalent) | | | | | | | |
| Relative Conjugation | 90% | 500% | 88% | 22% | 17% | 13% | 27% |
| Frequency | | | | | | | |

MIC (μg/mL)

| | | | | | | | |
|---|---|---|---|---|---|---|---|
| E. coli 1103 | 5.000 | 2.500 | 2.500 | 2.500 | 2.500 | 2.500 | 2.500 |
| E. coli ESBL 22664 | 5.000 | 2.500 | 2.500 | 2.500 | 2.500 | 2.500 | 2.500 |
| S. aureus 2569 | 5.000 | 5.000 | 2.500 | 2.500 | 2.500 | 2.500 | 2.500 |
| S.aureus MRSA 46320 | 5.000 | 5.000 | 2.500 | 2.500 | 2.500 | 2.500 | 2.500 |
| S. suis 9682 | 625 | 5.000 | 625 | 312 | 312 | 312 | 312 |
| Salmonella enterica | 10.000 | 5.000 | 5.000 | 5.000 | 5.000 | 5.000 | 5.000 |
| 19587 | | | | | | | |
| C. perfringens 756 | 2.500 | 2.500 | 2.500 | 2.500 | 2.500 | 1.250 | 2.500 |
| C. perfringens 2943 | 625 | 1.250 | 625 | 1.250 | 1.250 | 625 | 1.250 |
| P. aeruginosa 1117 | >10000 | 10.000 | >10000 | >10000 | 10.000 | 10.000 | >10.000 |
| E. hirae 3320 | 10.000 | 10.000 | 5.000 | 2.500 | 2.500 | 2.500 | 2.500 |

Further MIC values for other bacterial strains were determined for the feed additive of Example 7. The results are shown in the Table below.

TABLE 6
MIC values for various bacterial strains for
the feed additive of Example 7

| Bacterial strain | MIC (μg/ mL) |
|---|---|
| C. perfringens (field strain 1) | 312 |
| C. perfringens (field strain 2) | 312 |
| C. perfringens (field strain 3) | 312 |
| C. perfringens (field strain 4) | 312 |
| C. perfringens (field strain 5) | 156 |
| C. perfringens (field strain 6) | 312 |
| C. perfringens (field strain 7) | 1250 |
| C. perfringens (field strain 8) | 78 |
| C. perfringens (field strain 9) | 312 |
| C. perfringens (field strain 10) | 312 |
| C. perfringens (field strain 11) | 312 |
| C. perfringens (field strain 12) | 312 |
| C. perfringens (field strain 13) | 312 |
| Bacillus subtilis | 2500 |
| Bacillus licheniformis | 1250 |
| Enterococcus faecium | 5000 |
| Lactobacillus plantarum | 10000 |

The feed additive according to the invention has low MIC values for several Clostridium perfringens strains that are found in the field. Moreover, higher MIC values for the probiotic strains Bacillus spp., Enterococcus faecium and Lactobacillus plantarum were observed.

1. A feed additive comprising:
a first conjugate comprising a conjugation inhibitor; and
a second conjugate selected from the group consisting of a conjugation enhancer, a conjugation inert ingredient, and a combination thereof;
wherein the feed additive has an anti-oxidation activity of at least 1 TE.

2. The feed additive according to claim 1, wherein the feed additive has an anti-oxidation activity equal to or higher than the anti-oxidation activity observed for a control.

3. The feed additive according to claim 1, wherein the feed additive has antimicrobial activity with MIC values for Clostridium perfringens DSM 2943 of at most 2,000 pg/mL, Streptococcus suis DSM 9682 of at most 5,000 pg/mL, and Escherichia coli DSM 1103 of at most 5,000 pg/mL.

4. The feed additive according to claim 1, wherein the conjugation inhibitor is selected from the group consisting of oleic acid, linoleic acid, linalool and tannic acid.

5. The feed additive according to claim 1, wherein the conjugation enhancer is selected from the group consisting of carvacrol, citral, eugenol, methyl thymol and thymol.

6. The feed additive according to claim 1 further comprising a solvent.

7. A feed additive comprising:
a porous carrier;
a first conjugate comprising a conjugation inhibitor and a second conjugate selected from the group consisting of a conjugation enhancer, a conjugation inert ingredient, and a combination thereof, which first and second conjugates are adsorbed onto and/or absorbed into the porous carrier to form a filled porous carrier; and a protective coating applied to the filled porous carrier.

8. The feed additive according to claim 7, wherein the porous carrier is a precipitated silica.

9. The feed additive according to claim 7, wherein the protective coating is selected from vegetable oil and animal oil.

10. The feed additive according to claim 7, wherein the feed additive has a d50 of at most 500 μm.

11. A feed composition comprising:
the feed additive of claim 1;
wherein the amount of the feed additive is from 0.001 to 1 wt %, based on the feed composition.

12. A method of reducing using a conjugation inhibitor;
wherein reducing is selected from the group consisting of reducing the expression of hemolysin in bacteria, reducing the development of resistance in bacteria, and reducing a plasmid transfer caused by a conjugation enhancer.

13.-14. (canceled)

15. A feed composition comprising:
the feed additive of claim 7;
wherein the amount of the feed additive is from 0.001 to 1 wt %, based on the feed composition.
